(19) United States
(12) Patent Application Publication
(10) Pub. No.: US 2025/0369132 A1
(43) Pub. Date: Dec. 4, 2025

(54) COPPER-BASED ELECTROCATALYSTS FOR ELECTROCATALYTIC CARBON DIOXIDE REDUCTION REACTION AND THE FABRICATION METHODS AND APPLICATIONS THEREOF

(71) Applicant: City University of Hong Kong, Hong Kong (HK)

(72) Inventors: Zhanxi FAN, Hong Kong (HK); Pengyi LU, Hong Kong (HK)

(21) Appl. No.: 18/679,480

(22) Filed: May 31, 2024

(51) Int. Cl. C25B 11/048; B01D 53/32; B01D 53/86; C25B 3/03; C25B 3/26

(52) U.S. Cl. CPC C25B 11/048; B01D 53/326; B01D 53/8671; C25B 3/03; C25B 3/26; B01D 2255/20761; B01D 2257/504; B01D 2258/06

(57) ABSTRACT

A copper-based metal organic framework (MOF) electrocatalyst is provided. Particularly, it includes Cu-5-mercapto-1-methyltetrazole (Cu-MMT) nanostructured monomers, polymerized in an orthorhombic Pbca space group to form a MOF. Each Cu-MMT monomer has six Cu ions and six MMT ligands, forming a three-dimensional cylindrical structure. This structure exhibits a single-atom Cu point defect, induced by an unsaturated Cu atom, which facilitates the formation of multiple closely spaced bi-copper sites.

### FIELD OF THE INVENTION

The present invention generally relates to the field catalyst of catalysts. More specifically the present invention relates to copper-based metal organic framework (MOF) electrocatalysts for electrocatalytic CO₂ reduction reaction.

### BACKGROUND OF THE INVENTION

The substantial emission of carbon dioxide (CO₂) has led to widespread global environmental issues, including the greenhouse effect, seawater acidification, and rising sea levels. With CO₂ being an abundant carbon source in the atmosphere, electrochemically reducing it into chemical raw materials and energy using renewable electricity has emerged as a promising strategy. However, the electrocatalytic CO₂ reduction reaction (ECO₂RR) faces challenges, including competition from the hydrogen evolution reaction (HER) and the complexity of product formation due to diverse reaction steps. Selectivity for multi-carbon (C₂₊) products, particularly ethylene (C₂H₄), remains relatively low compared to single-carbon (C₁) products. Additionally, the reaction pathway and reactivity of ECO₂RR are influenced by catalyst surface properties and the local environment. Copper (Cu) stands out as a unique catalyst capable of converting CO₂ into C₂₊ products by coupling adsorbed *CO or *CHO intermediates, with high Faraday efficiency (FE). Various strategies, such as composition, morphology, defects, and surface modification, have been explored to enhance the activity and selectivity of Cu-based electrocatalysts for C₂₊ products in ECO₂RR. Thus, the urgent challenge is to develop Cu-based ECO₂RR catalysts with high energy efficiency, FE, and long-term stability to obtain C₂₊ products.

Metal-organic frameworks (MOFs) hold promise for ECO₂RR due to their large specific surface area, customizable porous structures, and precisely controllable active sites and coordination microenvironment. However, the distance between catalytic active sites in most MOFs often impedes effective C—C coupling, leading many pristine Cu-based MOFs to favor the generation of C₁ products over C₂₊ products. A viable solution is to design new structures or employ doping to create bi-copper active sites within the MOF. These sites, characterized by their suitable charge density, short Cu—Cu distances, and the hydrogen bonding ability of surrounding ligands, enhance CO intermediate coverage and promote C—C coupling reactions. Moreover, the fragile coordination bonds in self-assembled MOFs may compromise their stability as electrocatalysts. To address this issue, chemical bonds with strong binding energy, such as the Cu—S bond, can replace weaker bonds like Cu—O or Cu—N, ensuring structural integrity under low reduction potential. Additionally, Cu in the unstable+1 valence state has shown increased activity and selectivity for generating C₂₊ products compared to the common metallic state (Cu(0)) and Cu(II).

Considering the above factors, certain azole molecules can serve as ligands, ensuring that the Cu element within the nitrogen-rich MOF structure maintains exceptional stability in a highly active valence state during the ECO₂RR process. Additionally, precise control over the coordination of the electrocatalyst surface is vital for CO₂ activation and intermediate stabilization, directly impacting product selectivity. Studies have highlighted that under-coordinated Cu sites are particularly conducive to the electroreduction of CO₂ into C₂ hydrocarbons. Therefore, achieving high selectivity for C₂ products necessitates the selection of suitable azoles as ligands to design and synthesize stable MOF structures, featuring bi-copper sites, stable Cu(I) valence states, and highly active unsaturated Cu sites, as electrocatalysts.

In other words, the field is still searching for a Cu-based catalyst for ECO₂RR process that specifically produces C₂₊ products, such as C₂H₄, over C₁ products. Therefore, the present invention addresses this need.

### SUMMARY OF THE INVENTION

It is an objective of the present invention to provide a compound, material, device or method to solve the aforementioned technical problems.

In accordance with a first aspect of the present invention, a copper-based metal organic framework (MOF) electrocatalyst for electrocatalytic carbon dioxide reduction reaction (ECO₂RR) is provided. It includes a plurality of Cu-5-mercapto-1-methyltetrazole (Cu-MMT) nanostructured monomers configured in an orthorhombic three-dimensional (3D) interconnected structure with an interlayer spacing sized to capture CO₂ molecules for the ECO₂RR.

In accordance with one embodiment of the present invention, the plurality of the Cu-MMT nanostructured monomers is polymerized in an orthorhombic Pbca space group to form a copper-based MOF.

In accordance with another embodiment of the present invention, each of the Cu-MMT nanostructured monomers includes six Cu ions and six MMT ligands to form a 3D cylindrical structure.

In accordance with one embodiment of the present invention, each of the Cu-MMT nanostructured monomers exhibits a single-atom Cu point defect, which is caused by an unsaturated Cu atom.

In accordance with one embodiment of the present invention, the single-atom Cu point defect causes the monomer's structure to form multiple closely spaced bi-copper sites.

In accordance with one embodiment of the present invention, the unsaturated Cu atom is coordinated by two S atoms and one N atom from three symmetry-related MMT ligands, forming an unsaturated Cu-1S-2N coordination structure.

In accordance with one embodiment of the present invention, the unsaturated Cu-1S-2N coordination structure provides reactive sites for catalyzing carbon-carbon (C—C) coupling to generate multi-carbon (C₂₊) products.

In accordance with one embodiment of the present invention, the copper-based electrocatalyst exhibits a Faraday efficiency (FE) between 70-75% toward the C₂₊ products at −1.15 V vs reversible hydrogen electrode (RHE).

In accordance with one embodiment of the present invention, the Cu-based electrocatalyst exhibits a FE between 50-55% toward C₂H₄ products at −1.15 V vs RHE.

In accordance with a second aspect of the present invention, a method for fabricating the copper-based MOF electrocatalyst is introduced. The method includes the following steps:
adding a copper nanowire/isopropyl alcohol (IPA) solution into an MMT/IPA solution for vortexing for at least 1 minute to obtain a mixture at a defined temperature;
leaving the mixture in a chamber with a preset temperature for a duration; and
centrifugating the mixture for isolating a copper-based MOF electrocatalyst.

In accordance with one embodiment of the present invention, the concentration of the copper nanowires/IPA solution is between 0.1-1 mg mL-1, the concentration of the MMT/IPA solution is 0.5-6 mM, the defined temperature is room temperature, the preset temperature is between 4-6° C. and the duration is 10-16 hours. The obtained copper-based MOF electrocatalyst is a diamond-shaped MOF with a thickness of approximately 200 nm (Cu-MMT-1).

In accordance with another embodiment of the present invention, the concentration of the copper nanowire/IPA solution is between 0.1-1 mg mL-1, the concentration of the MMT/IPA solution is 0.5-6 mM, the defined temperature is room temperature, the preset temperature is 25° C. and the duration is 36 hours. The obtained copper-based MOF electrocatalyst is a diamond-shaped MOF with a thickness of approximately 700 nm (Cu-MMT-2).

In accordance with another embodiment of the present invention, the concentration of the copper nanowire/IPA solution is between 0.1-1 mg mL-1, the concentration of the MMT/IPA solution is 25 mM, the defined temperature is 0° C., the preset temperature is 0° C. and the duration is 36 hours. The resulted copper-based MOF electrocatalyst is a paddle-shaped MOF (Cu-MMT-3).

In accordance with another embodiment of the present invention, the concentration of the copper nanowire/IPA solution is between 0.1-1 mg mL-1, the concentration of the MMT/IPA solution is 50 mM, the defined temperature is 0° C., the preset temperature is 0° C. and the duration is 24 hours. The resulted copper-based MOF electrocatalyst is a broom-shaped MOF (Cu-MMT-4).

In accordance with one embodiment of the present invention, the amount of MMT added exceeds the amount of copper nanowire added, ensuring that the copper nanowire is fully reacted with no residue.

In accordance with a third aspect of the present invention, an energy conversion device is presented. Particularly, the device includes the aforementioned copper-based MOF electrocatalyst for conversing CO₂ existed in air or a waste gas into C₂H₄.

### BRIEF DESCRIPTION OF THE DRAWINGS

Embodiments of the invention are described in more details hereinafter with reference to the drawings, in which:

FIGS. 1A-1C depict a schematic illustration for Cu-MMT nanostructures, in which FIG. 1A shows the synthesis of Cu-MMT nanostructures, FIG. 1B displays the spatial geometry of Cu-MMT nanostructures and FIG. 1C shows Cu—Cu distances in the Cu-MMT nanostructures in an asymmetric unit or between adjacent unit;

FIGS. 2A-2B depicts the pore structure of Cu-MMT MOF, in which FIG. 2A shows the top view and FIG. 2B displays the side view thereof;

FIGS. 3A-3G depict the structural characterization of Cu-MMT-1, in which FIG. 3A shows the powder X-ray diffraction (PXRD) pattern along with the simulated one for comparison, FIG. 3B is a scanning electron microscope (SEM) image of Cu-MMT-1, FIG. 3C shows the energy-dispersive X-ray spectroscopy (EDS) elemental analysis results, FIG. 3D is a transmission electron microscope (TEM) image of Cu-MMT-1, FIG. 3E is another TEM image of Cu-MMT-1, FIG. 3F depicts Cu-MMT-1's selected area electron diffraction (SAED) pattern, and FIG. 3G demonstrates a SEM image and the corresponding elemental mappings of Cu-MMT-1;

FIGS. 4A-4L depicts the fine structure analysis of Cu-MMT-1, in which FIG. 4A shows the Fourier transform infrared (FT-IR) spectra of Cu-MMT-1, copper nanowires (CuNWs) and MMT, FIGS. 4B-4E respectively show the high-resolution X-ray photoelectron spectroscopy (XPS) spectra of N 1s (FIG. 4B), S 2p (FIG. 4C), Cu 2p (FIG. 4D), and Cu LMM (FIG. 4E) for Cu-MMT-1, FIG. 4F is a normalized Cu K-edge X-ray absorption near edge structure (XANES) spectra, FIG. 4G is a Fourier transform of k²-weighted extended X-ray absorption fine structure (EXAFS) spectra, FIG. 4H is a R space and inverse Fourier transform (inset) EXAFS fitting results of Cu K-edge for Cu-MMT-1; and FIGS. 4I-L respectively reveals a wavelet transform for the the k²-weighted Cu K-edge EXAFS spectra of Cu-MMT-1 (FIG. 4I), Cu₂S (FIG. 4J), copper phthalocyanine (CuPc) (FIG. 4K) and standard copper foil (FIG. 4L);

FIGS. 5A-5L depict the fine structure characterization of Cu-MMT, in which FIGS. 5A-5C respectively display the SEM images of Cu-MMT-2 (FIG. 5A), Cu-MMT-3 (FIG. 5B) and Cu-MMT-4 (FIG. 5C), FIG. 5D-5F respectively show the TEM images of Cu-MMT-2 (FIG. 5D), Cu-MMT-3 (FIG. 5E) and Cu-MMT-4 (FIG. 5F), FIG. 5G shows the PXRD patterns of as-prepared three Cu-MMT samples (Cu-MMT 2-4), together with the simulated one for comparison, FIG. 5H depicts the FT-IR spectra of Cu-MMT samples, FIG. 5I demonstrates the high-resolution XPS spectra of Cu LMM for Cu-MMT samples, FIG. 5J shows the high-resolution XPS spectra of Cu 2p for Cu-MMT samples, FIG. 5K is the normalized Cu K-edge XANES spectra of Cu-MMT samples, and FIG. 5L shows the Fourier transform of k²-weighted EXAFS spectra of Cu-MMT samples;

FIGS. 6A-6B depict the high-resolution XPS spectra of N 1s, and S 2p for four Cu-MMT samples, in which FIG. 6A is a N 1s spectra and FIG. 6B is a S 2p spectra;

FIGS. 7A-7C depict the spectra comparisons among Cu-MMT-1-4, Cu₂S and CuPc, in which FIG. 7A shows the normalized Cu K-edge XANES spectra, FIG. 7B is the partially enlarged image of normalized Cu K-edge XANES spectra, and FIG. 7C displays the Fourier transform of k²-weighted EXAFS spectra;

FIGS. 8A-8D depict the average FEs of various reduction products over Cu-MMT samples at different potentials, specifically, the Cu-MMT samples are Cu-MMT-1 (FIG. 8A), Cu-MMT-2 (FIG. 8B), Cu-MMT-3 (FIG. 8C) and Cu-MMT-4 (FIG. 8D);

FIGS. 9A-9F depicts the electrocatalytic performances of Cu-MMT samples toward CO₂RR, in which FIG. 9A shows the FE_{C2+} product percentage of total products, FIG. 9B displays the F_{EC2H4} product percentage of total products,

FIG. 9C displays the C₂₊/C₁ product ratio of total products, FIG. 9D depicts the C₂₊/C₁ product ratio of gas products, FIG. 9E shows the C₂H₄ partial current density of four Cu-MMT samples under different potentials, and FIG. 9F depicts the catalytic durability measurement of Cu-MMT-IPA at the potential of −1.1 V (vs reversible hydrogen electrode, RHE) for more than 12 h;

FIGS. 10A-10D depict the results of stability test, in which FIG. 10A depicts the PXRD patterns of Cu-MMT-IPA before and after the stability test, FIG. 10B and FIG. 10C both show the TEM images of Cu-MMT-1 after stability test for at the potential of −1.1 V vs RHE for more than 10 h, while FIG. 10D shows the SEM image thereof;

FIGS. 11A-11B depict the high-resolution XPS spectra of Cu 2p and Cu LMM for Cu-MMT-IPA before and after the stability test, specifically, FIG. 11A shows the high-resolution XPS spectra of Cu 2p and FIG. 11B displays the high-resolution XPS spectra of Cu LMM.

### DETAILED DESCRIPTION

In the following description, devices, materials, and/or methods of carrying out electrocatalytic carbon dioxide reduction reaction (ECO₂RR) and the likes are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

In accordance with a first aspect of the present invention, a copper-based metal organic framework (MOF) electrocatalyst for ECO₂RR is provided. Particularly, the copper-based MOF electrocatalyst including a multitude of Cu-5-mercapto-1-methyltetrazole (Cu-MMT) nanostructured monomers. These monomers exhibit a distinct polymerization pattern within an orthorhombic Pbca space group, forming a copper-based MOF. Each Cu-MMT nanostructured monomer is composed of six Cu ions and six MMT ligands, configuring a three-dimensional (3D) cylindrical structure. Notably, the Cu-MMT nanostructured monomer showcases a single-atom Cu point defect, attributed to an unsaturated Cu atom, thereby resulting in the formation of multiple closely spaced bi-copper sites. This single-atom Cu point defect is characterized by its coordination with two S atoms and one N atom from three symmetry-related MMT ligands, constituting an unsaturated Cu-1S-2N coordination structure. This structure facilitates the provision of reactive sites essential for catalyzing carbon-carbon coupling reactions, consequently generating multi-carbon (C₂₊) products. The electrocatalyst demonstrates a Faraday efficiency (FE) range of 70-75% towards C₂₊ products and an FE range of 50-55% towards ethylene (C₂H₄) products, both observed at −1.15 V (vs reversible hydrogen electrode, RHE).

In accordance with a second aspect of the present invention, a method for fabricating the aforementioned copper-based MOF electrocatalyst is introduced. The method involves several steps to ensure the formation of the desired MOF structure. Initially, an IPA-based solution containing copper nanowires (1 mg mL-1) is added to an IPA-based solution containing MMT (5 mM), followed by vortexing for at least 1 minute at room temperature. Subsequently, the resulting mixture is left in a chamber maintained at a preset temperature ranging for a duration of. After this incubation period, the mixture is centrifuged to isolate the copper-based MOF electrocatalyst.

In some embodiments, where the concentration of the copper nanowire/IPA solution is between 0.1-1 mg mL-1 and the concentration of the MMT/IPA solution is 0.5-6 mM with a reacting duration ranging between 10-16 hours, the resulting copper-based MOF electrocatalyst manifests as a diamond-shaped MOF with a thickness of approximately 200 nm. Alternatively, varying the parameters such as the duration and temperature of incubation can yield different MOF structures. For instance, increasing the duration to 36 hours at room temperature produces a copper-based MOF electrocatalyst with a thickness of approximately 700 nm, exhibiting a diamond-shaped MOF. Increasing the concentration of the MMT solution to 25 mM and maintaining a temperature of 0° C. during the incubation process can result in the formation of a paddle-shaped MOF. Also, adjusting the concentration of the MMT solution to 50 mM with the same temperature of 0° C. during the incubation process can form a broom-shaped MOF. These variations provide flexibility in tailoring the properties of the copper-based MOF electrocatalyst to suit specific applications.

It is worth noting that the amount of MMT added exceeds the amount of copper nanowire added, ensuring that the copper nanowire is fully reacted with no residue.

In accordance with a third aspect of the present invention, an energy conversion device is provided. Specifically, the device includes the aforementioned copper-based MOF electrocatalyst for conversing CO₂ existed in air or a waste gas into C₂H₄.

### EXAMPLES

### Example 1. Synthesis and Characterization of Copper-Based Mof Electrocatalysts Eco₂Rr

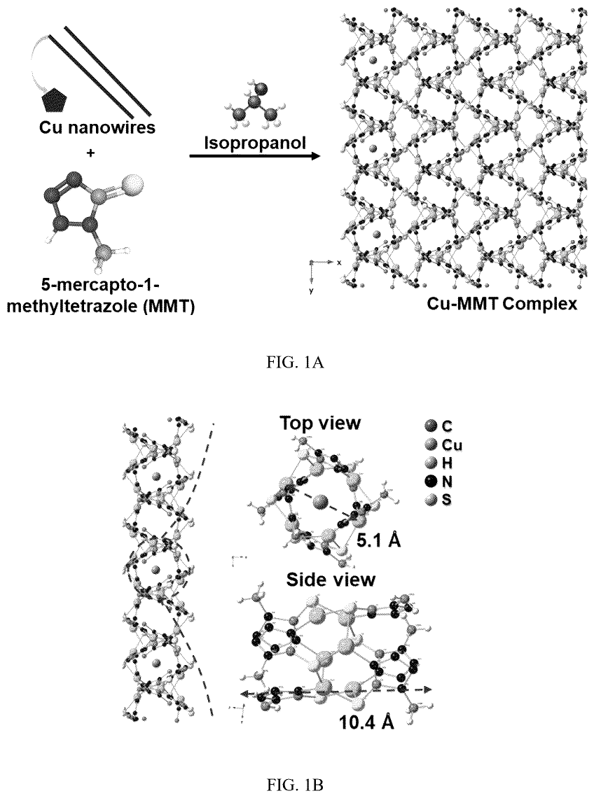

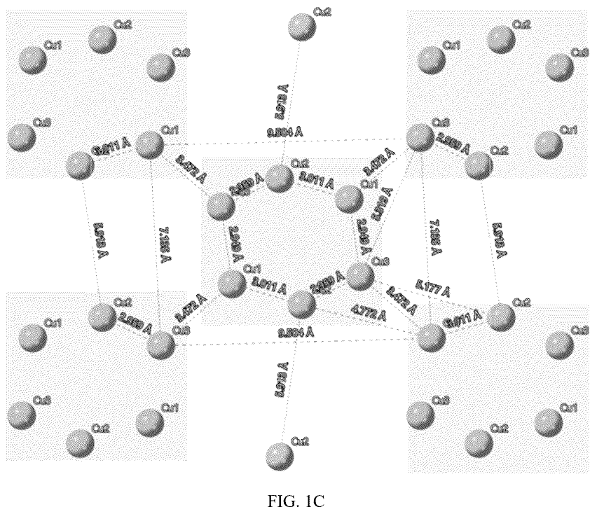

The copper-based MOF electrocatalysts are synthesized through the reaction of conjugated ligands of 5-mercapto-1-methyltetrazole (MMT) and copper source of Cu nanowires (CuNWs) in isopropyl alcohol (IPA) by adjusting different reaction temperatures, concentrations, and time (as shown in FIG. 1A). Briefly, the CuNWs are synthesized by dissolving copper (II) chloride dihydrate (CuCl₂·2H₂O) and glucose in deionized water (DI water) as solution A (blue clear liquid). Oleylamine (OAm) and oleic acid (OA) are mixed in ethanol as solution B (colorless transparent liquid). Then, Solution A and of DI water are slowly dripped into Solution B under vigorous magnetic stirring to form a homogeneous blue-green emulsion. Next, above mixture is sealed and transferred to water bath and kept stirring at 50° C. for 12 h. After the color of the mixture was turns cream yellow, it is transferred to autoclave and reacted at 110° C. for 6 h. After cooling down to room temperature, the products are separated from the solution with centrifugation (10,000 rpm for 6 min) and washed 3 times with a mixture of n-hexane/ethanol (v/v=3/1) mixture, 1 time with ethanol and 2 times with IPA. Finally, the precipitate CuNWs is dispersed into IPA (1 mg mL-1) via sight sonication. The fabricated CuNWs/IPA stock solution is first added into 5 mM MMT/IPA solution at room temperature, followed by intensively vortexed for 1 min. After that, the above mixture is immediately transferred to the refrigeration layer of the refrigerator (ca. 5° C.) and left to stand for 24 h. Next, the products are separated from the solution with centrifugation (6000 rpm for 5 min) and washed 4 times with IPA. Finally, the precipitate (Cu-MMT-1) is dispersed into IPA (1 mg mL-1) via sight sonication. The prepared electrocatalysts (Cu-MMT-1) is a diamond-shaped MOF with a thickness of 200 nm.

Importantly, the MOF prepared according to this method shows a novel structure that has never been reported, which is different from the common structure synthesized before (FIG. 1B). This novel Cu-MMT MOF reveals orthorhombic structure with space group of Pbca, each asymmetric unit contains six Cu ions and six MMT ligands forming a three-dimensional (3D) cylindrical structure, in which an unsaturated Cu atom is coordinated by two S atoms and one N atoms from three symmetry-related MMT ligand. The strong Cu—N and Cu—S bonds provide structural stability, and the unsaturated 3-coordination structure provides highly reactive sites. Due to the unique coordination mode, although the Cu sites in each cluster are independent of each other, they form a staggered ring at the central part of the cylinder in a short Cu—Cu distance (2.949-3.011 Å) (FIG. 1C).

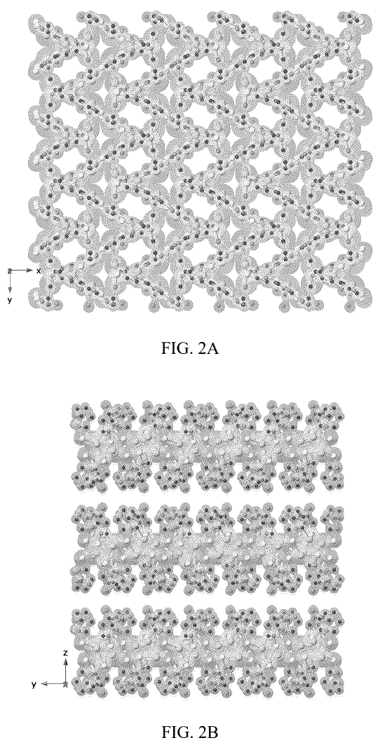

Moreover, extremely short Cu—Cu distance shows between adjacent active Cu ions (3.472-5.913 Å), which has been proved by many researchers to favor C—C coupling in CO₂RR to generate C₂₊ products. Importantly, large-diameter cylindrical monomer pore structures (approximately 5.5 Å) are vertically arranged to form a single layer structure, which vertically intersects to form a 3D interconnected structure with a large interlayer spacing (approximately 7 Å) (FIGS. 2A-2B). On the one hand, this optimized hole diameter is conducive to the efficient capture of CO₂ to ensure sufficient raw materials for the CO₂RR reaction. On the other hand, the optimized interconnected network structure helps the active sites to be more fully exposed and react better with CO₂ and various intermediates. In addition, the methyl group (—CH₃) as a side chain not only acts as an electron-donating group to affect the electron distribution of Cu atoms, making it more active, but also consistently faces the side of the interlayer structure to form an intrinsically hydrophobic layer, which is more conducive to the formation of the three-phase interface in the reaction.

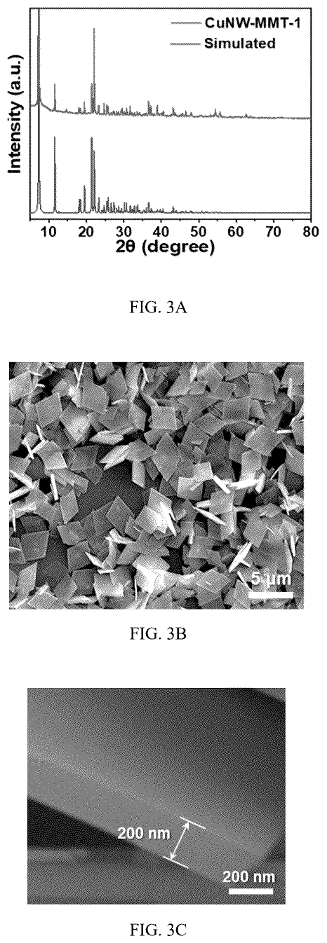

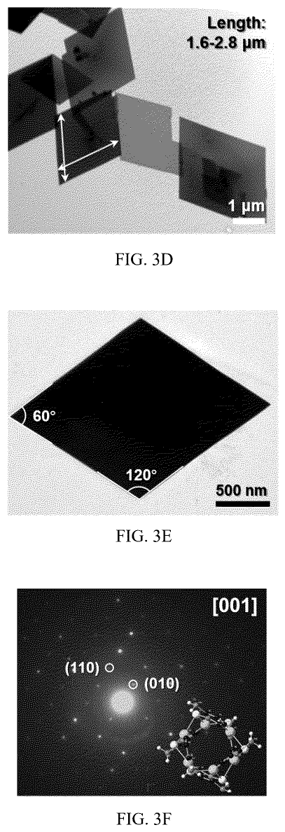

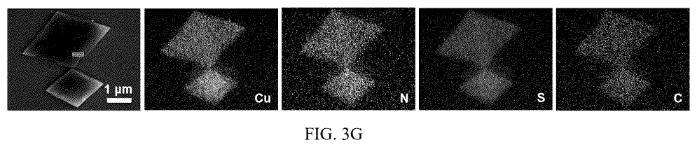

The PXRD patterns shown in FIG. 3A suggest that the crystal structure of Cu-MMT-1 is well consistent with the simulated one, indicating that the material is successfully synthesized. Moreover, the position of each diffraction peak does not shift and no peaks of metallic copper or other copper-based compounds are found, which proves that the reaction is complete and the product is highly pure and single. The detailed morphology and structure of Cu-MMT-1 is characterized by low/high-magnification SEM and TEM. As shown in FIGS. 3B-3E, the obtained Cu-MMT-1 exhibits diamond-shaped micro-sheet with smooth surface and uniform size, which has an average side length of 1.6-2.8 μm, and thickness of 185-210 nm, respectively. The SAED patterns of a single nanosheet show sharp diffraction spots with regularly arranged patterns, indicating that the Cu-MMT-1 is single crystalline with high crystallinity (FIG. 3F). The SEM-based EDS mappings of Cu-MMT-1 prove the homogeneous distribution of Cu, N and S the whole nanostructures (FIG. 3G).

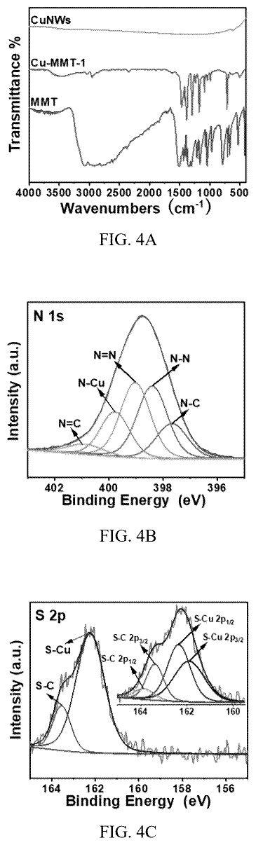

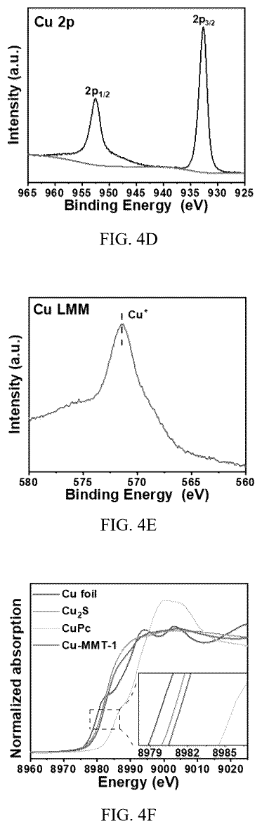

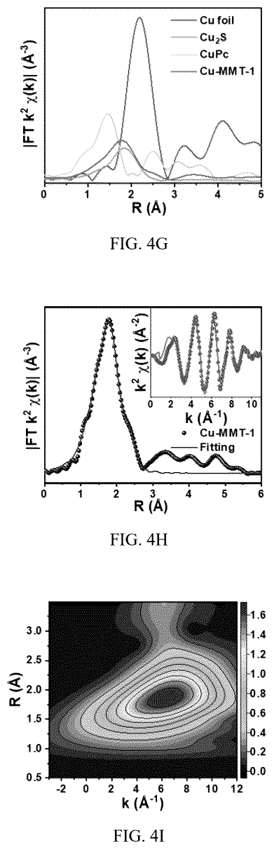

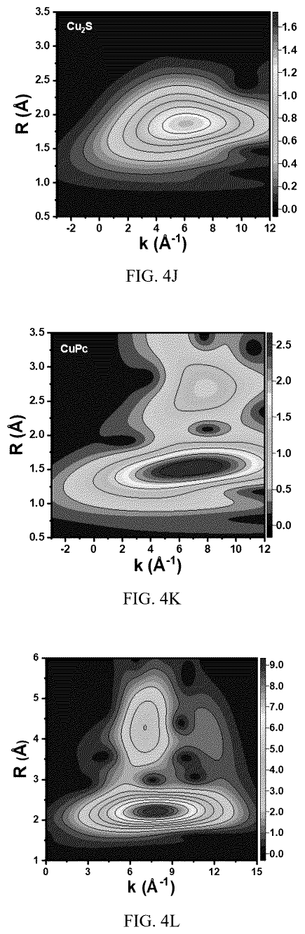

FT-IR, XPS, and XAFS spectroscopy are systematically characterized to elucidate the chemical structures and valence states of Cu-MMT-1. Firstly, the FT-IR spectra of the ligands and Cu-MMT-1 sample were acquired to identify the chemical structure (FIG. 4A). The H—N—C—S deformation, N—H deformation and C—N stretching vibration can be clearly seen in the FT-IR spectrum of Cu-MMT-1 sample, which confirms that the Cu—S and Cu—N coordination are formed and tetrazole ring is well preserved in the sample. Meanwhile, the peaks at ca. 400.5 eV in high-resolution N 1s spectra (FIG. 4B) and the peaks at ca. 162.6 eV in high-resolution S 2p spectra (FIG. 4C) from XPS characterization also confirm the above results. For the Cu valence state, the high-resolution Cu 2p XPS spectrum (FIG. 4D) shows peaks at 932.7 eV (2p 3/2) and 952.5 eV (2p 1/2), respectively, which are associated with the Cu⁺/Cu⁰ state; there is no Satellite peaks appear, proving that there is no Cu²⁺ state. This is attributed to the strong covalent interactions between the Cu—Cu, Cu—N and Cu—S ligand bonds, resulting in a lower Cu 2p binding energy. Cu LMM Auger spectra are measured to further elucidate the Cu valence states. A broad peak appears at the binding energy of 570.0 eV, further confirming that only Cu⁺ existed on the sample surface (FIG. 3E). Moreover, the aforementioned results suggest that the Cu (I) species are well coordinated by N atom and S atom of the MMT ligand in the Cu-MMT-1 sample. Meanwhile, the elemental composition analysis in both XPS and SEM-based EDS measurement show the ratio of C:N:S:Cu are match well with the standard structure within error limits.

The local coordination environments of Cu active centers in Cu-MMT-1 are further investigated by XAFS spectroscopy. As shown in FIG. 4F, the Cu K-edge XANES spectrum of Cu-MMT-1 is near-coincident and close to that of Cu₂S, suggesting the most +1 valence state of Cu in Cu-MMT-1, agreeing well with the XPS results. The Fourier transform (FT) of k²-weighted Cu K-edge EXAFS spectra is used to investigate the atomic environments of Cu sites (FIG. 4G and FIG. 4H). The dominant peak position of Cu-MMT-1 is between those of CuPc and Cu₂S standard samples, implying the coexistence of both Cu—N and Cu—S bonds in Cu-MMT-1 nanostructures. In more detail, the main peak is much closer to Cu₂S, which corresponds well to the coordination mode of one Cu with two S and one N in the structure.

The EXAFS fitting results confirm that the first shell scattering paths in both samples are Cu—N and Cu—S, and the bond lengths of Cu—N and Cu—S bonds in these samples are 1.90 Å and 2.21 Å, respectively, which slightly lower than the standard structures. Interestingly, the average coordination number of Cu—N and Cu—S is about 0.7 and 1.7, respectively, which is lower than 1 and 2 for the ideal structure. From this observation, it can be speculated that there are some Cu site vacancies defects or unsaturated Cu sites in Cu-MMT-1, and these defective sites may be more conducive to enhancing high electrocatalytic activity or selectivity for CO₂RR. More interestingly, there is an unconventional Cu—Cu bond, with the bond lengths of 2.50 Å, shown in the Cu-MMT-1. After comparing with many copper-containing materials, it can be easily found that such a close Cu—Cu distance only appears in copper-based inorganic compounds or metallic copper. The simulated structure is shown in the figure. In addition, the wavelet transform for Cu K-edge EXAFS spectra of Cu-MMT-1, standard Cu foil, Cu₂S and CuPc samples further display that the participation of both N and S atoms in the coordination with Cu in Cu-based MAF, as well as a small amount of Cu—Cu coordination (FIGS. 4I-4L). Combining the previous characterization results including XRD, HRTEM and SAED, it can be judged that the basic structure of Cu-MMT MAFs is stable, the chemical composition is relatively single, and the possibility of mixing in any other substances is excluded. After further analysis and simulation, the non-traditional closer Cu—Cu bonds may come from the remaining copper atoms in the Cu-MMT pore structure. Due to the low reaction kinetics caused by low reaction concentration, it is speculated that some copper ions were unfortunately trapped in the pores or structures of the Cu-MMT MAF porous structure during the reaction. Similar to the solvent molecules that usually remain in the pores of MOFs, a small amount of Cu ions may also remain inside the Cu-MMT tubular structure. Due to size limitations, the inserted copper ions are close to the copper ions in the surrounding barrel structure and are therefore detected as Cu—Cu coordination by EXAFS. It is worth adding that the remaining copper ions do not remain uniformly in each tubular pore and can only be attributed to point defects, which does not affect the overall crystal structure of Cu-MMT-1. This corresponds well to the characterization results of other structures and components mentioned previously.

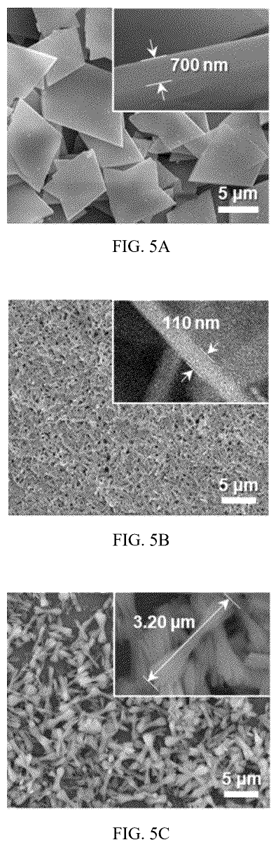

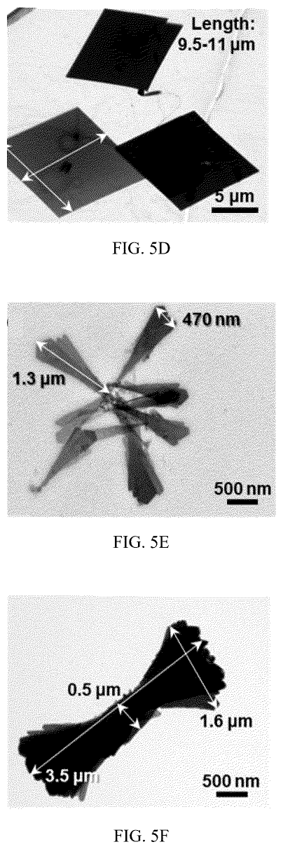

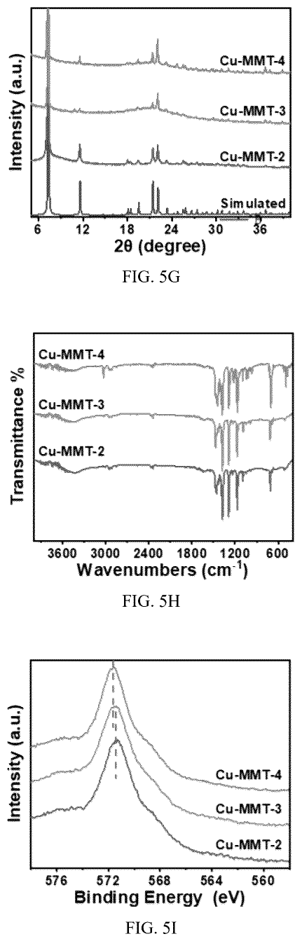

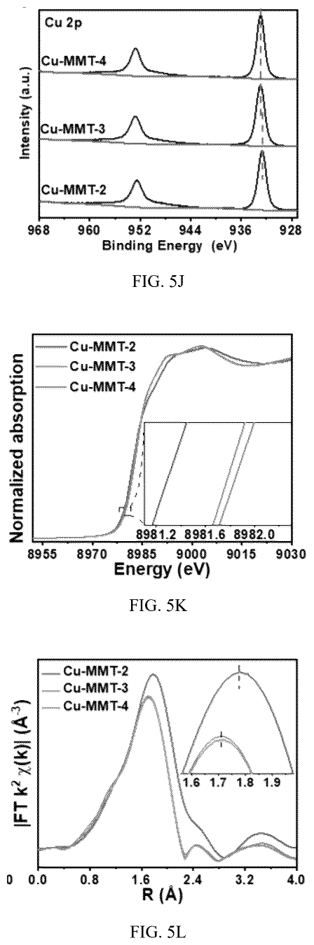

It is worth noting that the copper-based MOF electrocatalysts (named as Cu-MMT) may be in different sizes or morphologies by adjusting the fabrication parameters. For instance, for a diamond-shaped Cu-MMT MOF with a thickness of 700 nm (Cu-MMT-2), the CuNWs/IPA stock solution is first added into 5 mM MMT/IPA solution at room temperature, followed by intensively vortexed for 1 min. After that the above mixture is stand at 25° C.° for 36 h. Next, the products are separated from the solution with centrifugation (6000 rpm for 5 min) and washed 4 times with IPA. Finally, the precipitate (Cu-MMT-2) is dispersed into IPA (1 mg mL-1) via sight sonication. For the synthesis of paddle-shaped Cu-MMT MOF (Cu-MMT-3), the CuNWs/IPA stock solution is first added into 25 mM MMT/IPA solution at 0° C., followed by intensively vortexed for 1 min. After that the above mixture is immediately transferred to the ice-water bath (ca. 0° C.) and left to stand for 36 h. Next, the products are separated from the solution with centrifugation (6000 rpm for 5 min) and washed 4 times with IPA. Finally, the precipitate (Cu-MMT-3) is dispersed into IPA (1 mg mL-1) via sight sonication. For the synthesis of broom-shaped Cu-MMT MOF (Cu-MMT-4), the CuNWs/IPA stock solution is first added into 50 mM MMT/IPA solution, followed by intensively vortexed for 1 min. After that the above mixture is immediately transferred to the ice-water bath (ca. 0° C.) and left to stand for 24 h. Next, the products are separated from the solution with centrifugation (6000 rpm for 5 min) and washed 4 times with IPA. Finally, the precipitate (Cu-MMT-4) is dispersed into IPA (1 mg mL-1) via sight sonication. The SEM and TEM images show their morphologies in detail (FIGS. 5A-5F). When the reaction is maintained at the same low concentration of MMT (5 mM) as Cu-MMT-1 and the reaction time is only extended to 48 h, the obtained products still maintain the morphology of diamond-shaped micro-sheets with smooth surface, but its size and thickness are increased significantly (Cu-MMT-2, side length: 9.5-11 μm, thickness 700 nm, as shown in FIG. 5A and FIG. 5D). In view of the high forward reaction kinetics and spontaneity of this reaction, lower temperatures are used to reduce the reaction rate and to further achieve finer morphology control. As can be seen in FIG. 5B and FIG. 5E, when the reaction temperature is decreased to 0° C. accompanied by an increase in the reaction concentration of MMT to 25 mM, the resulting Cu-MMT MAFs (Cu-MMT-3) displays a well dispersed paddle-like morphology with the length about 1.3 μm, the width and thickness ca. 470 nm and ca. 110 nm, respectively. While, when continue to increase the reaction concentration of ligand to 50 mM at this low temperature (0° C.), and the product becomes a uniform double-headed broom-type structure (Cu-MMT-4), which can be seen as dozens of small “paddle-shaped” nanosheets gathered head-to-head (FIG. 5C and FIG. 5F). The size details of this broom-shaped structure are as follows, the length is ca. 3.5 μm, the width of the broom part is about 1.6 μm, and the thin part in the middle is 0.5 μm. In addition, the elements such as Cu, C, N, and S exist and are homogeneously distributed in each sample.

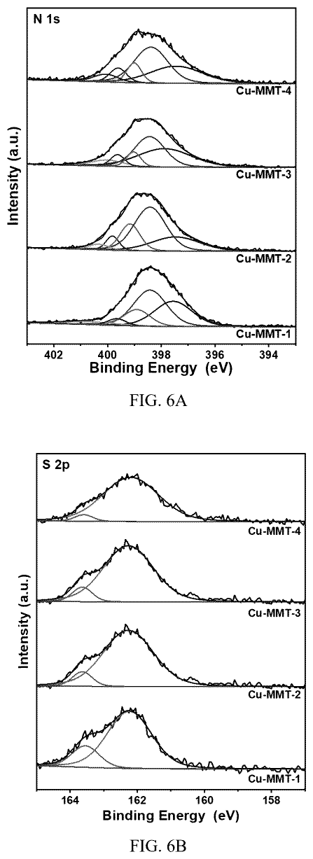

The PXRD patterns displayed in FIG. 5G show that all the synthesized samples are in good agreement with the simulated pattern, confirming the same novel structures of Cu-MMT and their good crystallinity. The FT-IR spectra of the three as-prepared samples show similar characteristic bands at the same position as Cu-MMT-1, and no additional peaks are detected (FIG. 5H). Combining with the N 1s and S 2p spectra of as-prepared 4 samples, the same bond formation of Cu—S and Cu—N in these samples are reconfirms once more (FIGS. 6A-6B). For the Cu valence state of these Cu-MMT, combined with the only one peak at ca. 571.5 eV in the Cu LMM spectra and no satellite peak in the high-resolution Cu 2p spectrum (only two peaks at ca. 932.6 eV (2p 3/2) and ca. 952.0 eV (2p 1/2)), it can be concluded that the Cu valence state of these Cu-MMT is +1 valence, which once again proves that the combination with MMT ligands can stabilize Cu in a lower valence state. Moreover, it is worth noting that the peak position of Cu-MMT-3 and Cu-MMT-4 shows a slight shift to the left compared with the Cu-MMT-1, 2, which means a slightly higher valence in these two samples (FIG. 5I and FIG. 5J). The high-resolution S 2p and N 1s spectra in FIGS. 6A-6B further confirm that as-synthesized 4 samples demonstrate the same exhibit the same coordination pattern.

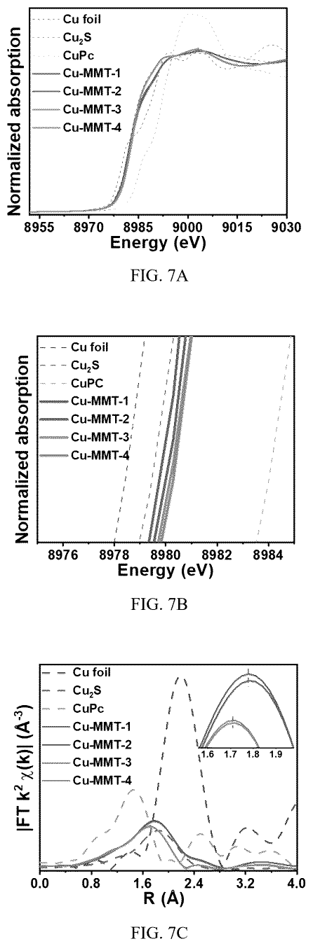

FIG. 5K and FIG. 7A show the XANES spectra of four samples are all near that of Cu₂S, which corresponds well to the Cu (I) oxidation state in Cu-MMT, reconfirm with the XPS analysis. In more detail, from the partially enlarged image in FIG. 7B, the valence state of Cu is observed in the prepared samples presents a trend of Cu₂S<Cu-MMT-2<Cu-MMT-1<Cu-MMT-3<Cu-MMT-4<<CuO. The Fourier transform results of k²-weighted R-space Cu K edge extended X-ray absorption fine structure (EXAFS) exhibit similar curves featuring a main peak at approximately 1.69 Å, arising from Cu—N bond and Cu—S bond (FIG. 5I and FIG. 7C). Furthermore, the main peak is closer to Cu₂S, which indicates that the Cu—S bond accounts for a larger proportion of Cu-MMT bonding, which is consistent with its crystal structure. Interestingly, by only comparing the results of these four as-prepared samples, the average Cu coordination in the two diamond-shaped samples exhibits a remarkable intensity increases and higher shift than that of the paddle-shaped sample and its aggregates (FIG. 7C). The fitting results and wavelet transform of the Cu K-edge further confirms that both N and S participate in the coordination with Cu (FIG. 4H and FIG. 4I). The coordination numbers of Cu—N and Cu—S bonds in the fitted samples are ca. 1 and 2, which matches the structure well within error. Importantly, Cu—Cu bond also shows in Cu-MMT-1 and Cu-MMT-2, which well explains the slightly lower valence state and higher average coordination radius of Cu in these two samples, expecting more excellent performance in electrocatalytic CO₂RR. The above characterization results suggest that Cu-MMT with advantages like the uniformly arranged structure, enrich low-valence and unsaturated Cu sites, and high porosity and stability might be much beneficial for its application as efficient electrocatalyst in electrochemical CO₂RR.

### Example 2. Evaluation of Electrocatalytic CO₂RR Performance of Cu-MMT Samples

The electrochemical CO₂RR performance of Cu-MMT catalyst decorated glassy carbon electrodes (GCE) is evaluated in a gas-tight H-cell setup using Pt foil as the counter electrode, Ag/AgCl electrode as the reference electrode, and 0.1 M KHCO₃ solution as electrolyte. Briefly, the synthesized Cu-MMT MOFs in the stock solutions are first centrifuged and washed carefully with IPA before preparing the working electrodes. To make the catalyst ink, 200 μg of the washed Cu-MMT nanostructures (based on Cu element) are added to the mixture of 200 μL of IPA and 5 μL of Nafion solution (5 wt. %). The resultant solution is sonicated in an ice-water bath for 20 min to get a well-dispersed catalyst ink. Then 50 μL of catalyst ink are dropped onto the GCE with a diameter of 8 mm. The obtained working electrodes are dried under ambient conditions for 20 min. After that, the as-prepared working electrodes are kept in vacuum oven before the electrocatalytic test.

CO₂RR experiments are carried out at reductive potentials varying from −1.0 to −1.25 V vs reversible hydrogen electrode (RHE). To evaluate the selectivity during the reaction, the gas and liquid products are monitored by online gas chromatography (GC) and 1H-nuclear magnetic resonance (1H NMR), respectively. C₂H₄, CH₄, CO, and H₂ are detected to be gas products and HCOOH, C₂H₅OH, C₃H₇OH, CH₃COOH, and CH₃CHO are detected to be liquid products in the system. Briefly, all the electrochemical measurements are conducted in a three-electrode system with an Ivium-n-Stat electrochemical workstation. The catalysts are tested in a gas tight two-chamber H-type cell separated by ion exchange membrane (Nafion 212). The CO₂-saturated 0.1 M KHCO₃ aqueous solution is used as the electrolyte. Typically, both anode and cathode chambers are filled with 8 mL of the electrolyte. The catalyst-modified GCE, Ag/AgCl electrode (filled with saturated KCl solution), and a Pt plate are applied as the working electrode, reference electrode, and counter electrode, respectively. All the potentials are measured versus an Ag/AgCl reference electrode with 85% iR compensation. The applied potentials are converted to reversible hydrogen electrode (RHE) scale using the equation of E (vs RHE)=E (vs Ag/AgCl)+0.197+0.0591×pH. All the applied potentials herein are recorded without solution resistance correction. Before the electrocatalytic test, the CO₂ gas (99.999%) is purged into the 0.1 M KHCO₃ aqueous solution in the cathode chamber for 30 min. During the test, the CO₂ gas is continuously purged into the electrolyte in the cathode chamber with a flow rate of 20 standard cubic centimeter per minute (sccm). The gaseous products of CO₂RR are analyzed directly by connecting the gas outlet of the cathode chamber to an on-line gas chromatography, which is equipped with two flame ionization detectors (FIDs) and a thermal conductivity detector (TCD) as well. After CO₂ electrolysis for 1 h, the liquid products in the cathode electrolyte are collected and analyzed by 1H nuclear magnetic resonance (NMR) spectroscopy. The FE of a certain gas product is calculated by the following equation:

$$FE = \frac{PV}{T} \times \frac{vNF}{I}$$

in which P, V and T represent the pressure (1 atm), gas flow rate (30 mL min-1) and room temperature (25° C.), and v, N, F, and I refer to the volume concentration of gas product, number of the electrons transferred in electrocatalysis, Faradaic constant, and current, respectively. The liquid products in the cathode chamber are collected after electrolysis and analyzed by 1H NMR spectroscopy. A mixed solution composed of 600 μL of electrolyte and 30 μL of dimethyl sulfoxide (DMSO) solution (0.035 vol. %, in deuterated water (D₂O)) is prepared for a typical NMR test.

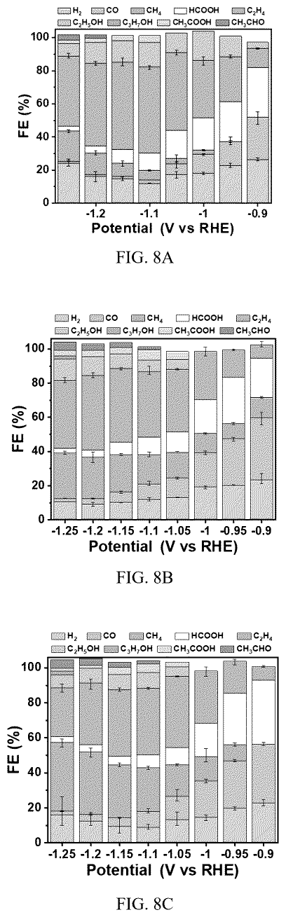

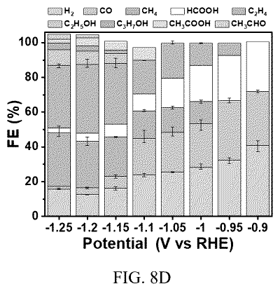

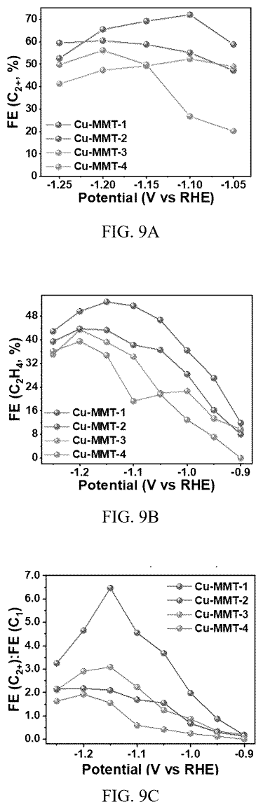

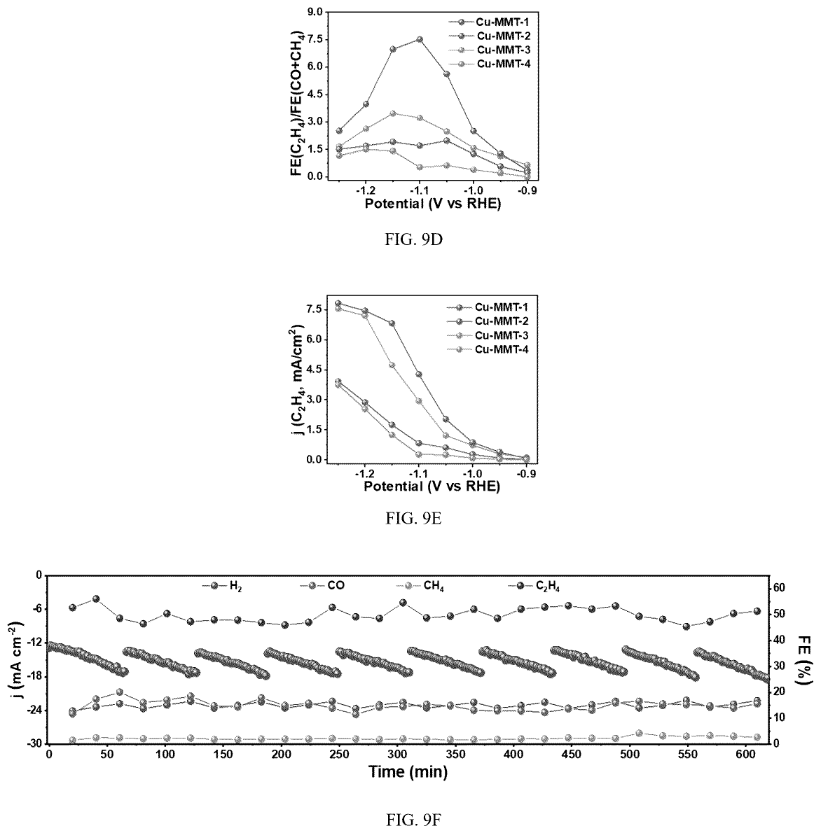

Average Faradaic efficiency (FE) of various reduction products over 4 samples at different potentials are shown in FIGS. 8A-8D. The total CO₂RR efficiencies and selectivities of each product vary similarly against the electrolysis potential. The total FEs of CO₂RR are larger than those of HER over the entire applied potential range and reach up to ca. 89.2% at −1.1 V vs RHE in Cu-MMT-1, and even ˜91.25% at −1.1 V vs RHE in Cu-MMT-3 sample, suggesting higher selectivity of Cu-MMT catalyst towards ECO₂RR than that of HER. As shown in FIG. 9A, for FE of high value-added C₂₊ products, the parallelogram microsheets with a thickness of about 200 nm shows performance in the wide voltage range and it achieves the highest FE (C₂₊) 74.04% at −1.15 V vs RHE). Among all the products, C₂H₄ is the most anticipated one and is pursued by many researchers. It is worth to noting that the best performance for purducing C₂H₄ also comes from Cu-MMT-1 (as shown in FIG. 9B, FE_{max(C2H4)}=52.83% at −1.15 V vs RHE). This is one of the highest values among the many Cu-based MOF catalysts that have been reported. In addition, the C₂₊/C₁ product ratio based on both total and gas products further confirmed the above conclusion. Impressively, Cu-MMT-1 achieves the highest C₂₊/C₁ product ratio of 6.47 at −1.05 V vs RHE (FIG. 9C). Meanwhile, for only gas products, a 7.52-fold in the ratio of C₂ (C₂H₄) to C₁(CO+CH₄), which is much higher than other 3 samples (FIG. 9D). In addition, for partial current density to C₂H₄, Cu-MMT-1 exhibits the highest value, with a maximum 7.82 mA cm 2 at −1.25 V vs RHE (FIG. 9E).

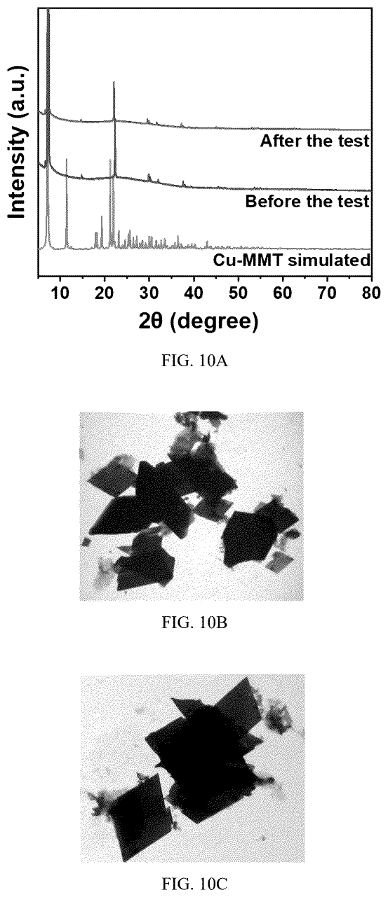

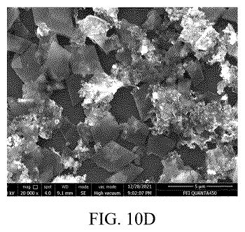

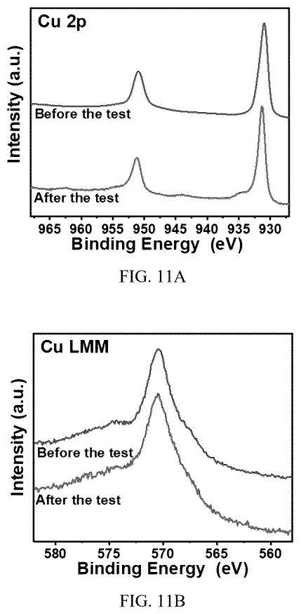

Furthermore, during continuous electrolysis at an applied potential of −1.15 V (vs RHE), Cu-MMT-1 exhibits excellent CO₂RR stability, retaining nearly unchanged FE (C₂H₄) (ca. 50%) for more than 12 h (FIG. 9F). Both no noticeable morphology change in SEM images and no peaks of Cu-based inorganic species (Cu(0), Cu₂O or CuO et al.) in XRD pattern are found in the post-electrolysis Cu-MMT-1 sample, which indicate that they can maintain their structural integrity after the electrochemical test (FIGS. 10A-10D). In addition, XPS characterization of Cu element before and after the test is detected to further confirm that, after stability testing, the valence state of Cu remains at a stable +1 valence with high catalytic performance, further verifying the stability of MAFs structure (FIGS. 11A-11B).

In summary, the present invention provides a facile room temperature solvent reaction method for the synthesis of unconventional Cu-MMT nanosheets (NSs), without the assistance of any surfactants. Four types of Cu-MMT nanostructures with different size and morphology can be obtained by adjusting reaction time, temperature, and concentration. Impressively, the obtained Cu-MMT NSs are composed of structurally stable cylindrical monomer structure with an unsaturated Cu-1S-2N coordination mode. Importantly, it is worth noting that some cylindrical monomers retain additional single-atom Cu point defects, which slightly affects the structure and creatively forms large numbers of closely spaced bi-copper sites. Furthermore, the consecutive cycling electrolysis measurement suggests the excellent catalytic durability of unconventional Cu-MMT NSs. Based on the optimized electronic structures, the C—C coupling trends are enhanced with alleviated energy barriers of C₂H₄ formation on unconventional Cu-MMT NSs with single-atom Cu point defects.

As used herein and not otherwise defined, the terms “substantially,” “substantial,” “approximately” and “about” are used to describe and account for small variations. When used in conjunction with an event or circumstance, the terms can encompass instances in which the event or circumstance occurs precisely as well as instances in which the event or circumstance occurs to a close approximation. For example, when used in conjunction with a numerical value, the terms can encompass a range of variation of less than or equal to +10% of that numerical value, such as less than or equal to +5%, less than or equal to +4%, less than or equal to +3%, less than or equal to +2%, less than or equal to +1%, less than or equal to +0.5%, less than or equal to +0.1%, or less than or equal to +0.05%.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated.

1. A copper-based metal organic framework (MOF) electrocatalyst for electrocatalytic carbon dioxide reduction reaction (ECO₂RR), comprising a plurality of Cu-5-mercapto-1-methyltetrazole (Cu-MMT) nanostructured monomers configured in an orthorhombic three-dimensional (3D) interconnected structure with an interlayer spacing sized to capture CO₂ molecules for the electrocatalytic carbon dioxide reduction reaction.

2. The copper-based MOF electrocatalyst of claim 1, wherein the plurality of the Cu-MMT nanostructured monomers is polymerized in an orthorhombic Pbca space group to form a copper-based MOF.

3. The copper-based MOF electrocatalyst of claim 1, wherein each of the Cu-MMT nanostructured monomers comprises six Cu ions and six MMT ligands to form a three-dimensional cylindrical structure.

4. The copper-based MOF electrocatalyst of claim 3, wherein each of the Cu-MMT nanostructured monomers exhibits a single-atom Cu point defect, which is caused by an unsaturated Cu atom.

5. The copper-based MOF electrocatalyst of claim 4, wherein the single-atom Cu point defect causes the monomer's structure to form multiple closely spaced bi-copper sites.

6. The copper-based MOF electrocatalyst of claim 4, wherein the unsaturated Cu atom is coordinated by two S atoms and one N atoms from three symmetry-related MMT ligands, forming an unsaturated Cu-1S-2N coordination structure.

7. The copper-based MOF electrocatalyst of claim 5, wherein the unsaturated Cu-1S-2N coordination structure provides reactive sites for catalyzing carbon-carbon (C—C) coupling to generate multi-carbon (C₂₊) products.

8. The copper-based MOF electrocatalyst of claim 7, wherein the copper-based MOF electrocatalyst exhibits a Faraday efficiency (FE) between 70-75% toward the C₂₊ products at −1.15 V (vs reversible hydrogen electrode, RHE).

9. The copper-based MOF electrocatalyst of claim 8, wherein the copper-based MOF electrocatalyst exhibits a FE between 50-55% toward C₂H₄ products at −1.15 V vs RHE.

10. A method for fabricating the copper-based MOF electrocatalyst of claim 1, comprising:
adding a copper nanowire/isopropyl alcohol (IPA) solution into a MMT/IPA solution for vortexing for at least 1 minute to obtain a mixture at a defined temperature;
leaving the mixture in a chamber with a preset temperature for a duration; and
centrifugating the mixture for isolating a copper-based MOF electrocatalyst.

11. The method of claim 10, wherein the concentration of the copper nanowire/IPA solution ranges from 0.1 to 1 mg mL-1, the concentration of the MMT/IPA solution is between 0.5-6 mM, the defined temperature is room temperature, the preset temperature is between 4-6° C. and the duration is 10-16 hours.

12. The method of claim 11, wherein the copper-based MOF electrocatalyst is a diamond-shaped MOF with a thickness of approximately 200 nm.

13. The method of claim 10, wherein the concentration of the copper nanowire/IPA solution is between 0.1-1 mg mL-1, the concentration of the MMT/IPA solution is 0.5-6 mM, the defined temperature is room temperature, the preset temperature is 25° C. and the duration is 36 hours.

14. The method of claim 13, wherein the copper-based MOF electrocatalyst is a diamond-shaped MOF with a thickness of approximately 700 nm.

15. The method of claim 10, wherein the concentration of the copper nanowire/IPA solution is between 0.1-1 mg mL-1, the concentration of the MMT/IPA solution is 25 mM, the defined temperature is 0° C., the preset temperature is 0° C. and the duration is 36 hours.

16. The method of claim 15, wherein the copper-based MOF electrocatalyst is a paddle-shaped MOF.

17. The method of claim 10, wherein the concentration of the copper nanowire/IPA solution is between 0.1-1 mg mL-1, the concentration of the MMT/IPA solution is 50 mM, the defined temperature is 0° C., the preset temperature is 0° C. and the duration is 24 hours.

18. The method of claim 17, wherein the copper-based MOF electrocatalyst is a broom-shaped MOF.

19. The method of claim 10, wherein the amount of MMT added exceeds the amount of copper nanowire added, ensuring that the copper nanowire is fully reacted with no residue.

20. An energy conversion device, comprising the copper-based MOF electrocatalyst of claim 1, wherein the device converses CO₂ existed in air or a waste gas into C₂H₄.
